(19) United States
(12) Patent Application Publication
(10) Pub. No.: US 2007/0033937 A1
(43) Pub. Date: Feb. 15, 2007

(54) Composite rotor for exhaust-gas turbochargers having titanium aluminide wheels

(75) Inventors: Hartmut Baur, Blaustein (DE); Peter Fledersbacher, Stuttgart (DE); Michael Scheydecker, Nersingen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/499,337

(22) Filed: Aug. 4, 2006

(30) Foreign Application Priority Data
Aug. 10, 2005 (DE) DE102005 037739.4

(51) Int. Cl. F04B 17/00; F02B 33/44; F04B 35/00

(52) U.S. Cl. 60/605.1; 417/407

(57) ABSTRACT

A rotor for exhaust-gas turbochargers having a turbine wheel (3) made of a metal aluminide, a hollow shaft (2) made of steel or of a nickel-based alloy, and a compressor wheel (1), the compressor wheel (1) having a journal (5), which partially extends into the hollow shaft (2) made of steel or of nickel-based alloy and which forms a positive connection (6) with the same, as well as a method for manufacturing rotors for exhaust-gas turbochargers having a turbine wheel (3), a metal hollow shaft (2), and a compressor wheel (1), including the steps of substance-to-substance bonding of the turbine wheel (3) and of the metal hollow shaft (2), positively connecting the compressor wheel and the metal hollow shaft (2), the positive connection (6) being produced by a journal (5) of the compressor wheel (1) projecting into metal hollow shaft (2), and by the inside of the metal hollow shaft.

The present invention relates to a rotor for exhaust-gas turbochargers having a turbine wheel made of a metal aluminide, a hollow shaft, and a compressor wheel, as well as to a method for the manufacture thereof with respect to joining the hollow shaft, turbine wheel and compressor wheel.

### BACKGROUND

The need exists in the automotive industry to replace turbocharger rotors made of steel with those made of light-metal alloys. In this context, the conventional one-piece turbocharger rotors made of steels are replaced with multipiece designs having a highest possible proportion of high-temperature resistant light-metal alloys, since, typically, the quality obtained when manufacturing all-metal aluminide parts is less than satisfactory. It has been established that, for reasons of strength, it is beneficial to continue manufacturing the axial shaft out of steel and to only manufacture the rotor or the compressor wheel out of light metal, respectively metal aluminide.

From the JP-A-2-78734, a turbocharger having a rotor and turbine wheel is known, where the turbine wheel made of γ-titanium aluminide (γ-TiAl) is joined to a steel shaft. Between the turbine wheel and the steel shaft, an intermediate piece made of a nickel-based alloy is provided, which is joined on one side to the turbine wheel in a friction welding process.

From the EP 0 590 197 B1, a method is known for joining a steel shaft having a compressor wheel to a γ-TiAl turbine wheel. In the process, the connection between the steel shaft and the turbine wheel is established by frictionally welding an intermediate piece made of a nickel-based alloy that is permanently joined to the steel shaft. The connection between the steel shaft and the connecting piece is preferably formed in another preliminary friction welding process.

A highly synchronous operation of the exhaust-gas turbocharger rotor is necessary when working with high rotational speeds and high compression ratios. When friction welding is employed for the joining process, the centering and balancing along the longitudinal axis of the rotor is only able to be achieved with difficulty.

Frequently, at least the compressor wheel is screw-coupled to the shaft of the exhaust-gas turbocharger rotor via a bushing. Typically, the screw connection can have a detachable design, which greatly facilitates repairs to the rotor or to the bearings. However, this results in a mechanical weakening of the compressor wheel. In response to elevated temperatures and temperature changes, screw connections of this kind are weakened over the long term.

### SUMMARY OF THE INVENTION

It is an object of the present invention to devise a rotor for exhaust-gas turbochargers which will feature high-endurance joins between the individual components and a low thermal conductivity between the turbine wheel and the compressor wheel and, respectively, the bearings of the shaft. It is also intended to provide a method suited for manufacturing the same.

The present invention provides a rotor for exhaust-gas turbochargers having a turbine wheel (3) made of a metal aluminide, a hollow shaft (2) made of steel or of a nickel-based alloy, and a compressor wheel (1), also referred to altogether as exhaust-gas turbocharger rotor, wherein the compressor wheel (1) has a journal (5) which partially extends into the hollow shaft (2) made of steel or of nickel-based alloy and which forms a positive connection (6) with the same.

The present invention also provides a method for manufacturing rotors for exhaust-gas turbochargers having a turbine wheel (3), a metal hollow shaft (2), and a compressor wheel (1), including the steps of substance-to-substance bonding of turbine wheel (3) and metal hollow shaft (2), and of positively connecting the compressor wheel and metal hollow shaft (2).

### BRIEF DESCRIPTION OF THE DRAWINGS

The present invention is described in greater detail below with reference to the schematic drawings, in which:

FIG. 1 shows the exhaust-gas turbocharger rotor in half section along the center axis through steel hollow shaft (2) having compressor wheel (1), turbine wheel (3), journal (5), positive connection (6) and substance-to-substance bond (7);

FIG. 2 is a view of the compressor-wheel side hollow shaft (2) having a slot (8) for a driving element; and

FIG. 3 illustrates the exhaust-gas turbocharger rotor in half section along the center axis through steel hollow shaft (2) having compressor wheel (1), turbine wheel (3), sleeve (4), positive connection (6) and substance-to-substance bond (7).

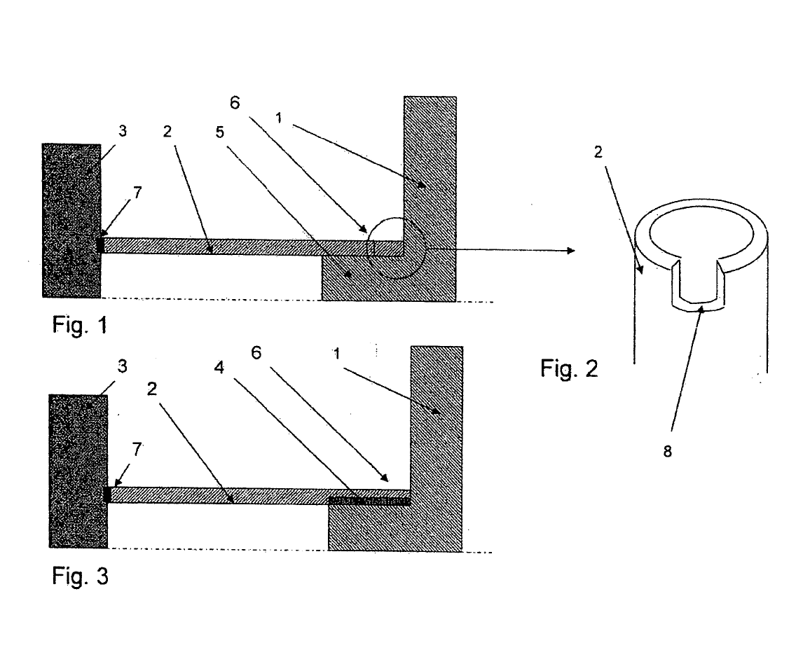

### DETAILED DESCRIPTION

It is thus provided in accordance with the present invention that the compressor wheel be joined by a positive connection to the hollow shaft made of steel or nickel-based alloy. This positive connection is produced by way of a journal (5) of compressor wheel (1) which partially extends into the hollow shaft made of steel or of nickel-based alloy. The journal of the turbine wheel and inner wall of the hollow shaft made of steel or of nickel-based alloy are designed in such a way that a permanent substance-to-substance bond is formed.

In comparison to friction-welding technology, this joining technique exhibits the advantage that the hollow shaft and the compressor wheel are able to be joined in a simple manner. On the other hand, special measures are required during friction welding processes to increase the connection surface area, since, by nature, the hollow shaft only has a small contact surface area.

In comparison to a solid shaft, the hollow shaft features the advantage of lower thermal conductivity and of low weight.

The substance-to-substance bond may be produced by employing various measures. In this context, edge forming, round kneading or mechanical interlocking are especially preferred. It is likewise advantageous when the hollow shaft made of steel or of nickel-based alloy is shrunk-fit onto the journal.

It is also a distinguishing feature of the substance-to-substance bond in accordance with the present invention that it is able to be produced with a very precise rotational symmetry with respect to the longitudinal axis of the shaft, respectively of the rotor. This ensures a high-quality synchronous operation, even at the highest rotational speeds.

In one preferred embodiment of the exhaust-gas turbocharger rotor, compressor wheel (1) does not have any recesses or material accumulations for balancing the rotor. It is especially preferred that neither the compressor wheel nor the turbine wheel have such devices for balancing purposes.

The substance-to-substance bond, in particular the mechanical interlocking, may be reinforced by microscopic roughenings or undercuts in the surface of the journal and/or on the inside of the hollow shaft. This eliminates the need for a thread; in the positive connection, preferably neither journal (5) nor hollow shaft (2) made of steel or nickel-based alloy has a thread.

In another preferred embodiment of the present invention, hollow shaft (2) on the side of the compressor wheel has at least one slot (8) for corresponding driving elements on journal (5). The slot is preferably as deep as the shaft, so that the driving element of the journal penetrates the hollow shaft from the inside to the outside. In the same way, however, provision may also be made in parallel to the longitudinal axis for a plurality of microscopic slots which correspond to conforming microscopic ridges extending in parallel in the journal. Slots and ridges then preferably have heights and, respectively, depths of 0.5 to 1 mm.

In one preferred embodiment of the present invention, the compressor wheel is made of an aluminum light-metal alloy, in particular of an Al—Mg alloy or of a titanium aluminide.

It is particularly advantageous when positive connection (6) has a detachable design. This is able to be implemented quite simply, particularly in the case of mechanical interlocking, when the hollow shaft made of steel or of nickel-based alloy is shrunk-fit onto the journal. The thermal expansion of the shaft and compressor wheel, and, respectively, of the journal made of different materials is utilized for assembly and disassembly operations.

Preferably, the diameter ratio of the hollow shaft made of steel or of nickel-based alloy and the journal, and the size of the overlap make it possible for the connection to be released by heating the hollow shaft made of steel or of nickel-based alloy and by cooling the compressor wheel made of aluminum alloy to a temperature difference of at least 300° C., without causing any damage to the components.

In particular, the detachable design of the connection between the journal and the hollow shaft makes it possible to remove the rotor from the bearing(s) in order to repair the same. This permits manufacture of closed bearings, which constitutes a substantial design simplification over split bearings.

Another variant provides for inserting a sleeve between the hollow shaft and the journal. The sleeve is designed to act as a buffer for mechanical loads. This is especially significant when thermal stresses occur during operation of the exhaust-gas turbocharger rotor. Thus, for example, the thermal expansion of aluminum in the compressor wheel is 23×10ˆ-6 1/K, and that of the steel hollow shaft 13-16×10ˆ-6 1 /K. The assembly and disassembly operations are facilitated in that different approaches are used for repairing the connection partners.

The sleeve is preferably made of a nickel-based alloy or of stainless steel and, in particular, of a Cu-based alloy or bronze.

However, instead of the sleeve, it is also possible to galvanically coat the journal with an equivalent alloy.

In the case of the mechanical interlocking produced by shrinking the hollow shaft onto the journal, an additional torsional retention is preferably provided.

The preferred embodiment of the exhaust-gas turbocharger rotor provides that the connection between hollow shaft (2) made of steel or of nickel-based alloy and turbine wheel (3) be a substance-to-substance bond. This substance-to-substance bond may be implemented using customary joining techniques. The connection that is especially preferred between steel hollow shaft (2), respectively the hollow shaft made of steel or of nickel-based alloy, and turbine wheel (3) is a welded connection, in particular one produced by friction welding. During the friction welding process, an intermediate piece made of a nickel alloy may be introduced to form a connection layer that is permanently joined on both sides to the hollow shaft and the turbine wheel.

Another variant provides for joining together hollow shaft (2) made of steel or of nickel-based alloy and turbine wheel (3) in a recasting or pouring-over process. It is advantageous to cast the hollow shaft in a turbine wheel made of titanium aluminide.

It is especially preferred for the turbine wheel to be produced from a titanium aluminide and the hollow shaft from steel. Compressor wheel (1) is preferably made of an aluminum alloy.

The exhaust-gas turbocharger rotor according to the present invention is preferably used in the exhaust system of motor vehicle combustion engines. In this context, the rotational speeds may be steadily and continuously above 80,000 rpm.

Another aspect of the present invention relates to a method for manufacturing rotors of this type for exhaust-gas turbochargers having a turbine wheel (3), a metal hollow shaft (2), and a compressor wheel (1). The essential steps of the method include:

substance-to-substance bonding of turbine wheel (3) and metal hollow shaft (2), as well as

positive connection of the compressor wheel and of metal hollow shaft (2), positive connection (6) essentially being produced by a journal (5) of compressor wheel (1) projecting into metal hollow shaft (2), and the inside of the metal hollow shaft.

In a first embodiment of the present invention, the journal is introduced into the hollow shaft, and the positive connection is produced by the subsequent mechanical action on the outside of the hollow shaft made of steel or of nickel-based alloy, in the region of the journal. The mechanical action, in particular, is produced by an edge forming or round kneading of the metal hollow shaft.

In another embodiment of the joining technique, the hollow shaft is shrunk-fit onto the journal. Thus, for example, the steel hollow shaft is heated to approximately 400° C., while the compressor wheel hub, respectively the journal, is cooled by liquid nitrogen or by drying the same. The two are fitted together and tempered to room temperature, an interlocking being produced in the process.

In this variant, the connection is easily rereleasable. The hollow shaft is heated in the connection region, for example, to approximately 200° C. by a hot-air blower, and the compressor wheel is sprayed with coolant spray. The Al alloy of the compressor wheel has an approximately four-times higher thermal conductivity than steel and, therefore, cools very quickly. Moreover, the thermal expansion is greater than that of steel by a factor of approximately two, so that the journal made of Al alloy undergoes a marked contraction.

The hollow shaft and the journal are preferably dimensioned in such a way that, at the coldest operating point, the positive connection exhibits an overlap of the hollow shaft and the journal of 0.01 to 0.1 mm.

In some instances, however, it may also suffice for disassembly purposes to use an extractor to pull down the compressor wheel. This is particularly the case when no undercuts or interlocked regions have been introduced into the hollow shaft and/or the journal.

In the case of repair and disassembly of the exhaust-gas turbocharger rotor, the compressor wheel is preferably replaced by a new one. This is advantageous for balancing operations.

Compared to the known rotors for exhaust-gas turbochargers having connections welded on both sides, i.e., permanent connections, this variant according to the present invention exhibits substantial advantages when repairing damages related to the particular application.

The exhaust-gas turbocharger rotor is able to be opened on one side and extracted from the bearings. When the rotor is reassembled, the substance-to-substance bond is also able to be restored using very simple means.

The connection is preferably produced in such a way that, during the process of forming the positive connection, a centering and/or a balancing of the rotor is carried out with respect to its longitudinal axis. The centering and balancing operations are coupled, for example, to the edge forming or round kneading processes.

Thus, one preferred process sequence provides for turbine wheel (3) and metal hollow shaft (2) to first be joined to one another in a friction-welding installation, and, subsequently thereto, for the positive connection to be produced between metal hollow shaft (2) and compressor wheel (1) in the same clamping installation or the same system. It is generally advantageous when the turbine wheel and metal hollow shaft are already joined to one another, as this simplifies the clamping process when connecting the compressor wheel.

It is expedient for the bearing(s) for the shaft to be installed after the turbine wheel is joined to the metal hollow shaft, and, only then, for the shaft of the exhaust-gas turbocharger rotor to be closed on both sides by attaching the compressor wheel. In this case, closed bearings may preferably be used.

A positive connection as defined herein can include a form-locking connection. A substance-to-substance bond includes a metallurgical or adhesive bond.

What is claimed is:

1. A rotor for exhaust-gas turbochargers comprising:
a turbine wheel made of a metal aluminide,
a hollow shaft made of steel or of a nickel-based alloy, and
a compressor wheel, the compressor wheel having a journal partially extending into the hollow shaft to form a positive connection with the hollow shaft.

2. The rotor for exhaust-gas turbochargers as recited in claim 1 wherein the positive connection is produced by edge forming or round kneading or by mechanical interlocking.

3. The rotor for exhaust-gas turbochargers as recited in claim 1 wherein, for the positive connection, the journal and the hollow shaft are threadless.

4. The rotor for exhaust-gas turbochargers as recited in claim 1 wherein the hollow shaft on a side of the compressor wheel has at least one slot for corresponding driving elements on the journal.

5. The rotor for exhaust-gas turbochargers as recited in claim 1 wherein the compressor wheel lacks any recesses or material accumulations for balancing the rotor.

6. The rotor for exhaust-gas turbochargers as recited in claim 1 wherein the positive connection is designed to be releasable between the compressor wheel and the shaft.

7. The rotor for exhaust-gas turbochargers as recited in claim 6 wherein the connection is releasable by heating the hollow shaft and by cooling the compressor wheel made of aluminum alloy to a temperature difference of at least 300° C.

8. The rotor for exhaust-gas turbochargers as recited in claim 1 wherein the connection between the hollow shaft and the turbine wheel is a substance-to-substance bond.

9. The rotor for exhaust-gas turbochargers as recited in claim 1 wherein the turbine wheel is made of a titanium aluminide.

10. The rotor for exhaust-gas turbochargers as recited in claim 1 wherein the connection between the hollow shaft and the turbine wheel is a welded connection.

11. The rotor for exhaust-gas turbochargers as recited in claim 1 wherein the compressor wheel is made of an aluminum alloy or of titanium aluminide.

12. A method for operating a rotor as recited in claim 1 comprising: operating the rotor in in an exhaust gas system of a motor vehicle internal combustion engine at rotational speeds above 80,000 rpm.

13. A method for manufacturing rotors for exhaust-gas turbochargers having a turbine wheel, a metal hollow shaft, and a compressor wheel, the method comprising the steps of
substance-to-substance bonding of the turbine wheel and of the metal hollow shaft,
positively connecting the compressor wheel and the metal hollow shaft via a connection produced by a journal of compressor wheel projecting into the metal hollow shaft and contacting an inside of the hollow metal shaft.

14. The method as recited in claim 13 wherein the positive connection is produced by a mechanical action on an outside of the hollow shaft in the region of the journal.

15. The method as recited in claim 13 wherein the positive connection is produced by edge forming or round kneading of the metal hollow shaft.

16. The method as recited in claim 13 wherein the positive connection is produced by shrinking of the hollow shaft onto the journal.

17. The method as recited in claim 16 wherein, at a coldest operating point, the positive connection exhibits an overlap of the hollow shaft and the journal of 0.01 to 0.1 mm.

18. The method as recited in claim 13 wherein, during the process of forming the positive connection, a centering or a balancing of the rotor is carried out with respect to its longitudinal axis.

19. The method as recited in claim 13 wherein the turbine wheel and the metal hollow shaft are joined to one another in a friction-welding installation, and, subsequently thereto, the positive connection is produced between the metal hollow shaft and the compressor wheel in a same clamping installation or a same system.
